(19) United States
(12) Patent Application Publication
(10) Pub. No.: US 2011/0051963 A1
(43) Pub. Date: Mar. 3, 2011

(54) METHOD FOR FINE-TUNING A HEARING AID AND HEARING AID

(75) Inventors: Roland Barthel, Erlangen (DE); Ulrich Giese, Erlangen (DE)

(73) Assignee: SIEMENS MEDICAL INSTRUMENTS PTE. LTD., Singapore (SG)

(21) Appl. No.: 12/868,884

(22) Filed: Aug. 26, 2010

(30) Foreign Application Priority Data
Aug. 28, 2009 (EP) 09168933
Feb. 11, 2010 (EP) 10153285

(51) Int. Cl. H04R 25/00

(52) U.S. Cl. 381/314

(57) ABSTRACT

The fine-tuning of the signal processing in a hearing aid or hearing aid system to the individual user should be simplified and improved. For this, the current hearing situation is recognized automatically and the user is automatically presented with a selection of questions from a comprehensive list of questions as a function of the hearing situation. A user input as a reaction of the user to the selected questions leads to the tuning of at least one parameter relating to the signal processing in the hearing aid.

### CROSS-REFERENCE TO RELATED APPLICATION

This application claims the priority, under 35 U.S.C. §119, of European application Nos. EP 09168933, filed Aug. 28, 2009, and EP 10153285, filed Feb. 11, 2010; the prior applications are herewith incorporated by reference in their entirety.

### BACKGROUND OF THE INVENTION

### Field of the Invention

The invention relates to a method for individual fine-tuning of the signal processing in a hearing aid to a user and to a hearing aid for carrying out the method.

Every hearing aid should be individually tuned to the respective hearing aid wearer in respect of amplification, frequency response and effect of adaptive algorithms. The relevant settings depend on, in particular, the loss of hearing, geometric parameters of the ear and the individual taste of the respective user. It is difficult to adjust the hearing aid as a function of the aforementioned individual parameters of the hearing aid wearer. Some of the input parameters are uncertain or can only be measured with great difficulty. Internationally evaluated formulae or manufacturer-specific algorithms provide a relationship between these input variables and the hearing aid settings (first fit). The hearing-aid audiologist subsequently performs individual fine-tuning. A problem with the fine-tuning is that the acoustic surroundings of the hearing aid wearer cannot be reproduced precisely in the shop. The upshot of this is that the optimum settings for the living surroundings of the respective user are not found in many cases.

Various procedures are known to solve this problem:

In the case of retrospective tuning, the user reports hearing problems to the audiologist, for example “The refrigerator is too noisy”. The audiologist then attempts to improve the settings of the hearing aid by applying their experience, but without having a precise idea of the problem. The user then has to return to the respective situation in order to try out the modified settings, and if need be return to the audiologist if the sound still does not correspond to the user's wishes.

In the case of interactive tuning using sound and video examples, an attempt is made to reproduce a scenario that is as realistic as possible of typical surroundings that the user frequents. Multichannel sound examples and matching video images give the user the illusion of being part of the presented events. However, the surroundings can never be displayed entirely realistically and, more particularly, the personal living space of the user cannot be imaged. By way of example, a conversation in the user's kitchen may sound completely differently than the conversation in the corresponding exemplary situation. Thus, the audiologist can in turn only tune general situations and finds it difficult to respond to precise requests of the user because the audiologist is unfamiliar with the precise preferred hearing surroundings of the user.

In the case of a hearing aid that can be trained, the hearing aid or a remote control provided for this provides various adjustment options by means of which the user can directly adjust the sound of their hearing aid in critical situations and over time the hearing aid “remembers” the preferences of the user in the various hearing situations. Of course, the adjustment options are however very limited (e.g. to volume, sound and noise removal) in order to avoid overburdening the user.

Commonly assigned U.S. Pat. No. 7,742,612 B2 and its counterpart German published patent application DE 103 47 211 A1 describes a method for retraining and operating a hearing aid, and a corresponding hearing aid. There, a classifier is trained for automatic identification of the current hearing situation by means of a neural network.

Commonly assigned U.S. Pat. No. 7,269,269 B2 and its counterpart European published patent application EP 1 453 356 A2 describes a method for adjusting a hearing system and a hearing system, in which an interactive tuning is carried out during operation. A classifier identifies various hearing situations and starts interactive tuning procedures within the scope of which various settings are to be evaluated. The settings are presented in this case as a function of the current hearing situation.

Commonly assigned U.S. Pat. No. 6,035,050 and its counterpart European published patent application EP 0 814 634 A1 describes a method for determining optimum parameter sets in a hearing aid. In the process, a plurality of parameters sets are stored for each of a plurality of hearing situations in a storage medium of a tuning arrangement. The user can then in a particular hearing situation select a particular parameter set from the parameter sets available for this hearing situation.

Disadvantages of known methods for individual fine-tuning of hearing aids are, on the one hand, the complexity thereof, as a result of which this fine-tuning can only be sensibly carried out in cooperation with a hearing-aid audiologist, and, on the other hand, the very limited adjustment options for the hearing aid in the case of methods that can be carried out in a simple fashion.

### SUMMARY OF THE INVENTION

It is accordingly an object of the invention to provide a hearing aid and a method for fine-tuning a hearing aid which overcome the above-mentioned disadvantages of the heretofore-known devices and methods of this general type and which provides for a method for the individual fine-tuning of the signal processing in a hearing aid or hearing aid system to a user and a corresponding hearing aid or hearing aid system, in which the fine-tuning can be carried out easily and more particularly by the user themselves, but nevertheless offers comprehensive adjustment options.

With the foregoing and other objects in view there is provided, in accordance with the invention, a method for individual fine-tuning of the signal processing in a hearing aid or hearing aid system to a user. The method includes the following steps:

recording an acoustic input signal and converting it into an electrical input signal,

identifying a hearing situation with the aid of the electrical input signal;

adjusting at least one parameter relating to the signal processing as a function of the identified hearing situation;

providing a list of questions;

selecting at least one question from the list of questions as a function of the hearing situation;

presenting the selected question to the user;

registering a user input as a reaction of the user to the selected question;

tuning the parameter as a function of the user input.

With the above and other objects in view there is also provided, in accordance with the invention, a hearing aid or hearing aid system which comprises:

an input transducer for recording an acoustic input signal and converting the latter into an electrical input signal,

a classifier for identifying a hearing situation with the aid of the electrical input signal,

adjustment means for adjusting at least one parameter relating to the signal processing as a function of the identified hearing situation,

storage means for providing a list of questions,

selection means for selecting at least one question from the list of questions as a function of the hearing situation,

output means for presenting the selected question to the user,

input means for registering a user input as a reaction of the user to the selected question,

means for tuning the parameter as a function of the user input.

A hearing aid according to the invention is understood to be any piece of equipment supplying an output signal that can be perceived by a user as an acoustic signal or contributing to the supply of such an output signal, and which has means that serve or contribute to compensating for an individual loss of hearing of the user. More particularly, these are hearing aids that can be worn on the body or the head, more particularly on or in the ear, and hearing aids that can be partly or entirely implanted. However, this also includes such equipment whose main purpose does not lie in the compensation of a loss of hearing, for example equipment from entertainment electronics (television sets, hi-fi equipment, MP3-players, etc.) or communication equipment (cellular telephones, PDAs, head sets, etc.), but which does comprise means for compensating for an individual loss of hearing.

A hearing aid system made of two hearing aid units, more particularly hearing aids, that can be worn on or in the ear is generally used for binaural care of a user. In addition to at least one hearing aid that can be worn on or in the ear, a hearing aid system can furthermore also comprise at least one further unit, for example an external processor unit that can be worn on the body of the user. By way of example, the external processor unit can be used for controlling the hearing aid or hearing aid system remotely, but it can additionally also perform further functions, for example analyzing the acoustic hearing surroundings.

A hearing aid generally comprises an input transducer for recording an input signal. The input transducer is, for example, designed as a microphone that records an acoustic signal and converts the latter into an electrical signal. However, units that have a coil or an antenna can also be considered for an input transducer, which units record an electromagnetic signal and convert the latter into an electrical signal. A hearing aid usually furthermore comprises a signal-processing unit for processing and frequency-dependently amplifying the electrical signal. A preferably digital signal processor (DSP), whose method of operation can be influenced by programs or parameters that can be transmitted to the hearing aid, is used for signal processing in the hearing aid. This allows tuning of the method of operation of the signal-processing unit to both the individual loss of hearing of a hearing aid wearer and the current hearing situation in which the hearing aid is currently operated. The electrical signal modified in this fashion is finally supplied to an output transducer. The latter is generally designed as a receiver, which converts the electrical output signal into an acoustic signal. However, other embodiments are also possible in this case, e.g. an implantable output transducer that is directly connected to auditory ossicles and causes the latter to oscillate.

The hearing aid or hearing aid system according to the invention comprises means for analyzing the electrical input signal for automatically identifying the hearing situation in which the hearing aid is currently being operated. These means are usually referred to as a “classifier”. The signal processing in the hearing aid is then carried out as a function of the hearing situation as a result of the parameters relating to the signal processing being adjusted automatically in accordance with the identified hearing situation. By way of example, these have an effect on the set amplification, the frequency response, the directional characteristic, certain filter settings, etc. It is conventional for a multiplicity of parameters to be tuned accordingly as a function of the current hearing situation. A set of parameter settings for a particular hearing situation is referred to as a hearing program in this context. Modern hearing aids have hearing programs for hearing situations such as “voice in quiet surroundings,” “voice in noise,” “driving in a car,” “phoning,” “watching television,” etc.

Up until now, fine-tuning the parameter sets to the preferences of the individual user required many tuning sessions with a hearing-aid audiologist. In the process, the user had to answer a multiplicity of questions to the audiologist in order to ascertain in which hearing situations and how the individual hearing programs needed modification such that the user is content with their hearing aid in all hearing situations. The number of possible questions and the complexity of the adjustment options have previously not allowed the user to carry out the fine-tuning themselves.

The hearing aid or the hearing aid system according to the invention comprises a storage means, more particularly a non-volatile storage medium, in which a list of questions with a multiplicity of relevant questions for the various hearing situations is stored. Answering all possible questions would be much too confusing, time-consuming and complicated for the user and can therefore not be expected of them.

The basic idea of the invention now consists of automatically presenting the user wearing their hearing aid in their usual surroundings with a specifically tailored selection of questions for the respective hearing situation from the comprehensive list of questions, which questions relate to problems usually occurring specifically in the respective hearing situation. If the user is unhappy in a certain hearing situation with the current hearing aid settings and therefore sees need for action for fine-tuning, they can react in a simple fashion to at least one presented question. The number of questions to which the user can react and the number of questions selected for a particular hearing situation can vary. In the simplest case, the hearing aid or hearing aid system selects precisely one question in each hearing situation identified thereby and offers said question to the user so that they can react thereto. However, it is also possible for a plurality of questions to be selected and presented in a particular hearing situation. The number of questions presented in a particular hearing situation preferably varies and can be set by the user or a hearing-aid audiologist. The precise number can also depend on the respective hearing situation, and so, for example, there is a particular hearing situation in which only one question is ever offered, whereas three questions are selected from the comprehensive list of questions for another hearing situation. If a plurality of questions are offered for a particular hearing situation, the user can alternate between the various questions either by actuating an operating element or by voice control. Furthermore, if there are a plurality of selected questions, e.g. questions 1 to 3, a reaction of the user to the first question 1 can automatically lead to question 2 being presented next and finally question 3 in an according fashion, and it is possible to react to this. After a reaction to the last question, question 1 is advantageously once again provided for the purpose of responding thereto. Moreover, in the case of a plurality of selected questions it is also possible for these to be presented successively in time, for example with an interval of 10 seconds, and the reaction of the user is always assigned to the currently presented question.

Selection means for fixing which question or questions is or are presented in which hearing situation can for example be embodied as an allocation table stored in the hearing aid or hearing aid system. Here, the allocation can be fixed by the hearing-aid audiologist or by the manufacturer of a relevant hearing aid or hearing aid system.

The following table shows, in an exemplary fashion, the selection and allocation of different questions to particular hearing situations:

| Current hearing | Hearing | Selected |
|---|---|---|
| situation | program | questions |
| The user is in the | Voice in quiet | Is the voice too quiet? |
| living room. The | surroundings at | Too much reverberation? |
| news is on the radio. | medium level | |
| The user moves to the | Voice in noise | Is the ambient noise too loud? |
| kitchen, the voice | and bad signal- | Was this sound too loud? |
| becomes very quiet. | to-noise ratio | A deep, quiet noise signal |
| Cutlery rattles. The | | was detected. Should it remain |
| refrigerator hums. | | audible? |
| The telephone rings. | Telephone | An alarm signal was |
| The user goes to the | | recognized. Should the signal |
| telephone and | | be accentuated next time? |
| answers. | | Should the other sounds be |
| | | damped more while phoning? |
| The user listens to | Voice in quiet | Is the voice intelligible? |
| quiet voice in quiet | surroundings at | |
| surroundings | low level | |

In particular, a display, which is preferably on an external processor unit that can be connected to the hearing aid, or voice output is advantageously considered as an output means for presenting a question relevant to a particular hearing situation.

If need be, the user reacts to a presented question by means of input means present directly on the hearing aid or on an external processor unit comprised thereby. More particularly, these input means include operating elements such as switches, buttons, controllers, etc., but also for example means for voice input. The questions are preferably formulated such that simple answers, preferably “yes/no” answers, are possible. Thus, the response can generally be brought about by a single actuation of an operating element. However, it is also possible for a multiplicity of alternative answers to be possible for a selected question. The user is then advantageously presented with a list of answers matching the selected question, from which list the user can then choose the matching prescribed answer in a simple fashion.

In a preferred embodiment, different reaction options are possible for different selected questions. Thus, for example, the question “Change volume?” can lead to the volume being adjusted in accordance with the duration or frequency of the +/− buttons being actuated. Merely a yes/no answer may also be possible and expedient for other questions, e.g. “Switch on noise removal?”.

The hearing aid or hearing aid system according to the invention furthermore comprises means for tuning the current hearing program, i.e. at least one parameter relating to the signal processing in the hearing aid, as a function of the user input. More particularly, the hearing aid or hearing aid system comprises a control arrangement that controls the conversion of the user input into a corresponding parameter adjustment. Here, the allocation of possible answers to the questions in respect of particular parameter values or parameter changes is preferably stored in a table in the relevant hearing aid system.

In principle, all method steps (recording the acoustic input signal, identifying the hearing situation, adjusting the parameter, providing the list of questions, presenting the selected question, registering the user input, tuning the parameter) required in the context of the invention can be carried out by means of a hearing aid according to the invention that can be worn on or in the ear of the user. However, due to the complexity thereof, the method steps are advantageously at least in part carried out by means of external equipment, e.g. an external processor unit, that is comprised of the relevant hearing aid system. In particular, this can also increase the user friendliness.

An input of the user as a reaction to a presented question advantageously has an immediate effect on the parameter settings of the hearing aid in the relevant hearing situation. The modified settings preferably also affects the settings when the hearing aid later again switches to the corresponding hearing program. Hence, the hearing aid learns the modified settings.

In a particularly advantageous refinement of the hearing aid or hearing aid system according to the invention, the “learning” does not directly adopt the last value of a relevant parameter, but there merely is a gradual approximation of the value to the last set value from the original value. Here, the degree of the approximation in particular depends on the duration of the new value being effective and/or the frequency of the user modifying the original settings within a certain period of time. Spontaneous, short-term and infrequent changes of the settings by the user therefore have a smaller effect than frequent or long-term tuning.

Other features which are considered as characteristic for the invention are set forth in the appended claims.

Although the invention is illustrated and described herein as embodied in a method for fine-tuning a hearing aid and hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic view of a hearing device system with a hearing aid and an external processor unit; and

FIG. 2 shows a flowchart illustrating the method according to the invention.

### DETAILED DESCRIPTION OF THE INVENTION

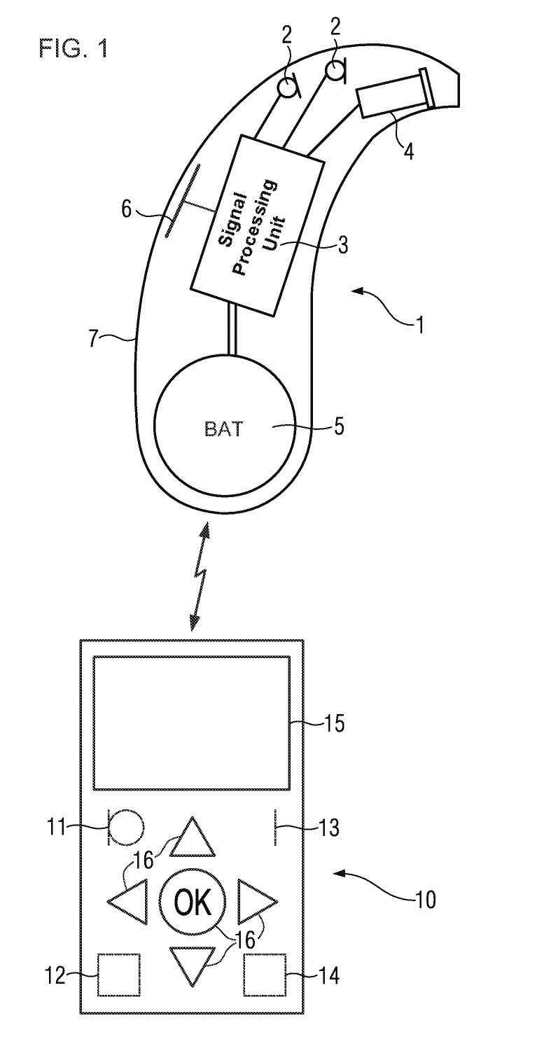

FIG. 1 shows a much-simplified block diagram of the design of a hearing aid system with a hearing aid, more particularly a behind-the-ear hearing aid 1, and an external processor unit 10. In principle, the main components of hearing aids are an input transducer, an amplifier and an output transducer. In general, the input transducer is designed as a sound receiver, more particularly a microphone. Hearing aids often comprise a plurality of microphones for forming a directional microphone system. Additionally, or alternatively, an electromagnetic receiver, e.g. an induction coil, can also be considered as an input transducer. The output transducer is usually designed as an electroacoustic transducer, e.g. a miniaturized loudspeaker or receiver, or as an electromechanical transducer, e.g. a bone conduction receiver. The amplifier is usually integrated into a signal-processing unit.

In the embodiment as per FIG. 1, two microphones 2 for recording sound from the surroundings are fitted into a hearing aid housing 7 provided to be worn behind the ear. A signal-processing unit 3, which is likewise located in the hearing aid housing 1, processes the microphone signals and amplifies them. The output signal from the signal-processing unit 3 is transmitted to a loudspeaker or receiver 4, which outputs an acoustic signal. If necessary, the sound is transferred to the eardrum of the user using a sound tube, which is fixed in the auditory canal with an ear mold. A battery 5 likewise arranged in the hearing aid housing 1 supplies the hearing aid and in particular the signal-processing unit 3 with energy.

The hearing aid 1 is connected to an external processor unit 10 via a signal path for wireless signal transmission, which external processor unit inter alia also serves as a remote control for the hearing aid 1. Said processor unit forms the interface to the user and provides the computational power for the method. The hearing aid 1 comprises an antenna 6 and the external processor unit 10 comprises an antenna 13 for the purpose of wireless signal transmission. The external processor unit 10 furthermore comprises a microphone 11 for recording an acoustic input signal and converting the latter into an electrical input signal, and a signal-processing unit 12 for processing the electrical input signal. The external processor unit 10 continuously analyzes the electrical input signal using complex models and many classes in respect of a multiplicity of hearing situations. The known MPEG-7 method is preferably used as a starting point for this. In particular, the hearing aid system 1, 10 can thereby distinguish between many different hearing situations. The complexity of the used algorithms means that in the exemplary embodiment these cannot be calculated in the hearing aid 1, but only in the external processor unit 10.

In addition to the electrical input signal generated in the external processor unit 10, the input signals generated in the hearing aid 1 or the signals arising therefrom (e.g. the signal level information from the input signals) can also be transmitted to the external processor unit 10 and can at least also be used for the classification there.

An artificial intelligence in each case derives questions specific to the situation from the detected hearing situations, which questions permanently appear on a display 15 of the external processor unit 10 and/or are provided orally by voice output when desired. More particularly, the signal-processing unit 12 selects as a function of the detected hearing situation at least one relevant question for the detected hearing situation from a comprehensive list of questions stored in a storage medium 14. In an ideal case, the selected question can be answered by “yes” or “no.” For this, the operating elements 16 are available on the external processor unit 10. A one-dimensional scale (more-less, louder-quieter . . . ) is advantageously provided for some questions. The user can use the display 15 and the operating elements 16 to answer the displayed question or questions at any time or to alternate between questions if there are a plurality of questions selected in respect of the current hearing situation. However, an answer is only required if the user sees need for action and they accordingly want to concern themselves with the hearing aid 1 at that time.

Answering a question generally brings about the change in a parameter relating to the signal processing in the hearing aid 1. Here, the new value of the relevant parameter is preferably calculated in the external processor unit 10. In the calculation, use can be made of known algorithms, which are for example used by hearing-aid audiologists in the tuning software.

The invention allows tuning in precisely the individual hearing surroundings of the user without the fine-tuning appearing to be bothersome in the process.

The acoustic classification of the hearing situation and the structured fine-tuning dependent thereon always offer the user options for fine-tuning their hearing aid without being confused or overburdened by the complexity of the adjustment options. The user is merely asked one question or a small number of questions that is or are expedient in the current acoustic situation and therefore is or are simple to answer.

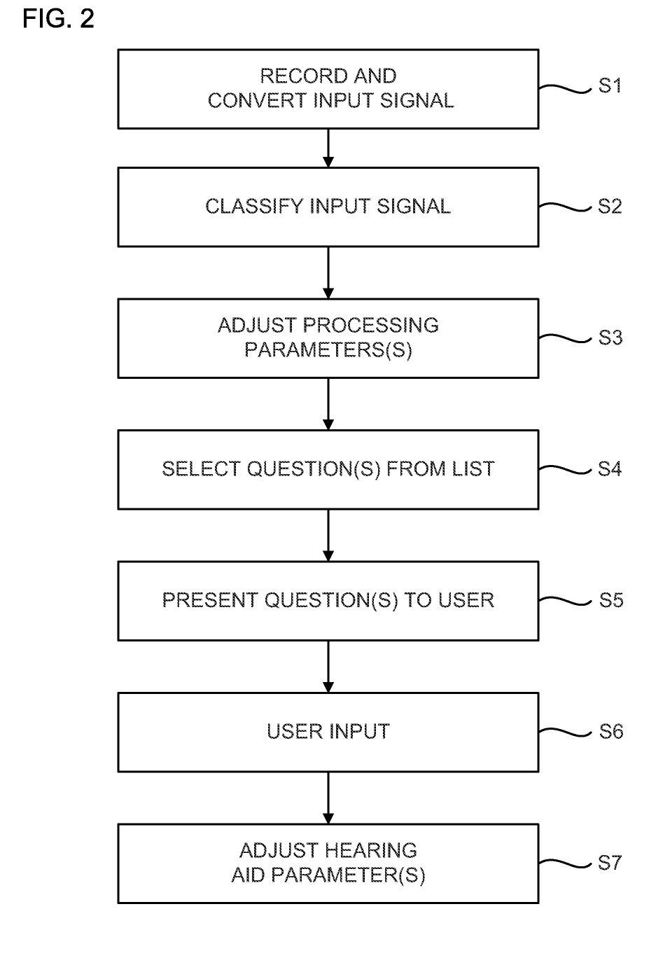

FIG. 2 shows a flowchart when carrying out a method according to the invention.

An acoustic input signal is recorded and converted into an electrical input signal in a first method step S1. In the context of the invention, this method step is preferably carried out in hearing aid equipment worn on the head, more particularly a hearing aid. However, in the context of the invention, this method step can also be carried out in an external processor unit.

In the subsequent method step S2, the electrical input signal is analyzed by means of a signal-processing unit for identifying the hearing situation in which the hearing aid and the external processing unit are at that time. This process is also referred to as “classification” and the corresponding part of the signal-processing unit or the software responsible for this is referred to as a “classifier”. The classification outputs the hearing situation at that time in which the hearing aid and the hearing aid system are as a result, for example “voice in noise.”

As a reaction to the identified hearing situation, at least one parameter relating to the signal processing of the acoustic input signal in the hearing aid is adjusted as a function of the identified hearing situation in the subsequent method step S3, i.e. the value of the parameter is matched to the hearing situation. In the process, the value range can be binary (e.g. noise removal algorithm on or off) or vary over a large value range (e.g. amplification between 0 dB and 100 dB). However, in general, an entire set of parameters, a so-called hearing program, is adjusted as a reaction to the identified hearing situation.

In addition to the hearing program, at least one question is also selected from a comprehensive list of questions as a function of the identified hearing situation in a method step S4, which question addresses a typical problem for the respective hearing situation. The list of questions contains a collection of questions for all or a multiplicity of the hearing situations that can be detected by the hearing aid or the hearing aid system. A question or a small number of questions relevant to the particular hearing situation is or are selected from the collection and presented to the user in a subsequent method step S5. The presentation is preferably brought about with the aid of a display present on the external processor unit or by voice output. The questions are preferably posed such that simple answers (yes/no, +/−, etc.) are possible. If a multiplicity of answers or more complex answers are possible, the hearing aid system preferably provides a catalog of expedient answers to the respective question, from which the applicable answer can easily be selected. This increases the ease of operation.

If the classification leads to an ambiguous result, a corresponding question could also provide the most likely hearing situation present from the point of view of the hearing aid or hearing aid system with a question mark e.g. “voice in noise?”. If this does not correspond to the actual hearing situation, the user could communicate this to the hearing aid by means of an appropriate input and thus even attain a fine-tuning of the classifier.

If the user deems a change of the current hearing aid settings to be expedient, the user can react to the presented question or questions by executing an appropriate input as an answer to the question in method step S6. Here, the input can be brought about by manual actuation of an operating element, preferably with the aid of the external processor unit, or advantageously by means of voice input.

At least one parameter relating to the signal processing in the hearing aid is tuned in method step S7 as a reaction to the undertaken input.

The selected question or selected questions is or are preferably presented and, if need be, a reaction thereto is registered until a new hearing situation is recognized and new questions are thereupon selected from the list of question as per the invention as a function of the hearing situation.

1. A method for user-individual fine-tuning of signal processing in a hearing aid, the method which comprises:
recording an acoustic input signal and converting the acoustic input signal into an electrical input signal;
identifying a hearing situation with the aid of the electrical input signal;
adjusting at least one parameter relating to the signal processing in dependence on the hearing situation identified in the identifying step;
providing a list of questions;
selecting at least one question from the list of questions in dependence on the hearing situation;
presenting the selected question to the user;
acquiring a user input as a reaction of the user to the selected question; and
tuning at least one parameter of the signal processing in the hearing aid in dependence on the user input.

2. The method according to claim 1, which comprises providing an external unit, external to the hearing aid, and performing at least one of the following steps with the external unit: recording the acoustic input signal, recognizing the hearing situation; adjusting the parameter; providing the list of questions; presenting the selected question; registering the user input; and/or tuning the parameter.

3. The method according to claim 1, which comprises presenting the selected question by voice output.

4. The method according to claim 1, which comprises presenting the selected question on a display.

5. The method according to claim 1, wherein the user input is acquired through manual actuation of an operating element.

6. The method according to claim 1, wherein the user input is acquired through voice input.

7. The method according to claim 1, wherein the user input also affects adjusting the parameter if the relevant hearing situation is subsequently recognized again.

8. A hearing aid or hearing aid system configured to carry out the method according to claim 1, comprising:
an input transducer for recording an acoustic input signal and for converting the acoustic signal into an electrical input signal;
a classifier connected to receive the electrical input signal and configured to identify a given hearing situation with the aid of the electrical input signal;
an adjustment device connected to said classifier for adjusting at least one parameter relating to signal processing in dependence on an identified hearing situation identified by said classifier;
a memory containing a list of questions;
a selection device connected to said memory for selecting at least one question from the list of questions in dependence on the hearing situation;
an output device connected to said selection device for presenting the selected question to the user;
an input device for registering a user input as a reaction of the user to the selected question;
means for tuning the parameter as a function of the user input.

9. The hearing aid system according to claim 8, comprising at least one hearing aid to be worn on or in the ear of a user and an external processor unit.

10. The hearing aid system according to claim 9, wherein said external processor unit is a remote control unit for said hearing aid.

11. The hearing aid system according to claim 9, wherein said external processor unit comprises a display forming the output device.

12. The hearing aid system according to claim 9, wherein said external processor unit comprises at least one operating element forming said input device.

13. A hearing aid or hearing aid system, comprising:
an input transducer for recording an acoustic input signal and for converting the acoustic signal into an electrical input signal;
a classifier connected to receive the electrical input signal and configured to identify a given hearing situation with the aid of the electrical input signal;
an adjustment device connected to said classifier for adjusting at least one parameter relating to signal processing in dependence on an identified hearing situation identified by said classifier;
a memory containing a list of questions;
a selection device connected to said memory for selecting at least one question from the list of questions in dependence on the hearing situation;
an output device connected to said selection device for presenting the selected question to the user;
an input device for registering a user input as a reaction of the user to the selected question;
means for tuning the parameter as a function of the user input.

14. The hearing aid system according to claim 13, comprising at least one hearing aid to be worn on or in the ear of a user and an external processor unit.

15. The hearing aid system according to claim 14, wherein said external processor unit is a remote control unit for said hearing aid.

16. The hearing aid system according to claim 14, wherein said external processor unit comprises a display forming the output device.

17. The hearing aid system according to claim 14, wherein said external processor unit comprises at least one operating element forming said input device.
